(19) United States
(12) Patent Application Publication
(10) Pub. No.: US 2019/0228196 A1
(43) Pub. Date: Jul. 25, 2019

(54) Limited-time 2D barcode generator

(71) Applicant: Hung Yuan Wang, Kaohsiung City (TW)

(72) Inventor: Hung Yuan Wang, Kaohsiung City (TW)

(21) Appl. No.: 16/373,650

(22) Filed: Apr. 3, 2019

(51) Int. Cl. G06K 7/10; G06K 19/06; G06K 7/14

(52) U.S. Cl. CPC G06K 7/10821; G06K 7/1417; G06K 19/06037

(57) ABSTRACT

A device for generating a limited-time 2D barcode symbol is provided. In one embodiment, the device includes a casing; a display on the casing for showing a barcode symbol; a MCU in the casing and electrically connected to the display, the MCU being capable of generating a limited-time 2D barcode symbol and sending same to the display for display, or deleting the 2D barcode symbol after a time limit of the 2D barcode symbol has expired; and a power supply in the casing and electrically connected to both the MCU and the display.

### BACKGROUND OF THE INVENTION

### 1. Field of the Invention

The invention relates to barcode generators and more particularly to a device for generating a limited-time 2D barcode symbol.

### 2. Description of Related Art

A barcode is an optical, machine-readable representation of data. The data usually describes something about the object that carries the barcode. Traditional barcodes systematically represent data by varying the widths and spacings of parallel lines, and may be referred to as linear or one-dimensional (1D). Later, two-dimensional (2D) barcodes were developed, using rectangles, dots, and other geometric patterns.

The Universal Product Code (UPC) is a barcode symbology that is widely used in many countries for tracking trade items in stores. For example, 2D barcodes are used to order food in restaurants (e.g., fast food restaurants). However, there is a drawback in this application. In detail, a customer may can the barcode symbol with a smartphone for ordering food. Thereafter, the barcode symbol is posted on the Internet by the customer. Thus, an individual may scan the barcode symbol with a smartphone to order food from a place not in the restaurant which does not provide take-out services and/or cannot process such ordering. This act may bother the restaurant.

Thus, the need for improvement still exists.

### SUMMARY OF THE INVENTION

It is therefore one object of the invention to provide a device for generating a limited-time 2D barcode symbol.

In a first aspect of the invention, there is provided a device for generating a limited-time 2D barcode symbol, comprising a casing; a display disposed on the casing and configured to show a barcode symbol; a microcontroller unit (MCU) disposed in the casing and electrically connected to the display, the MCU being configured to generate a limited-time 2D barcode symbol and send same to the display for display, or delete the 2D barcode symbol after a time limit of the 2D barcode symbol has expired; and a power supply disposed in the casing and electrically connected to both the MCU and the display.

Preferably, the casing is portable.

Preferably, the casing includes a pushbutton.

Preferably, the MCU is configured to activate wirelessly.

Preferably, the power supply is either a primary cell or a rechargeable battery.

In a first aspect of the invention, there is provided a device for generating a limited-time 2D barcode symbol, comprising a display disposed on a digital device and configured to show a barcode symbol; and a microcontroller unit (MCU) in the digital device and electrically connected to the display, the MCU being configured to generate a limited-time 2D barcode symbol and send same to the display for display, or delete the 2D barcode symbol after a time limit of the 2D barcode symbol has expired.

Preferably, the MCU is configured to activate wirelessly.

Preferably, the digital device is a computer, a tablet computer, or a smartphone.

The invention has the following advantages and benefits in comparison with the conventional art: the MCU may generate a limited-time 2D barcode symbol and send same to the display for display, or delete the 2D barcode symbol after the time limit has expired. Thus, the 2D barcode symbol is effective only during a set time period. Further, an individual may use a smartphone to activate the MCU to above perform above functions.

The above and other objects, features and advantages of the invention will become apparent from the following detailed description taken with the accompanying drawings.

### BRIEF DESCRIPTION OF THE DRAWINGS

FIG. 1 is a perspective view of a device for generating a limited-time 2D barcode symbol according to a first preferred embodiment of the invention;

FIG. 2 is a broken-away perspective view of the device;

FIG. 3 is a perspective view of a device for generating a limited-time 2D barcode symbol according to a second preferred embodiment of the invention; and

FIG. 4 is a broken-away perspective view of the device of FIG. 3.

### DETAILED DESCRIPTION OF THE INVENTION

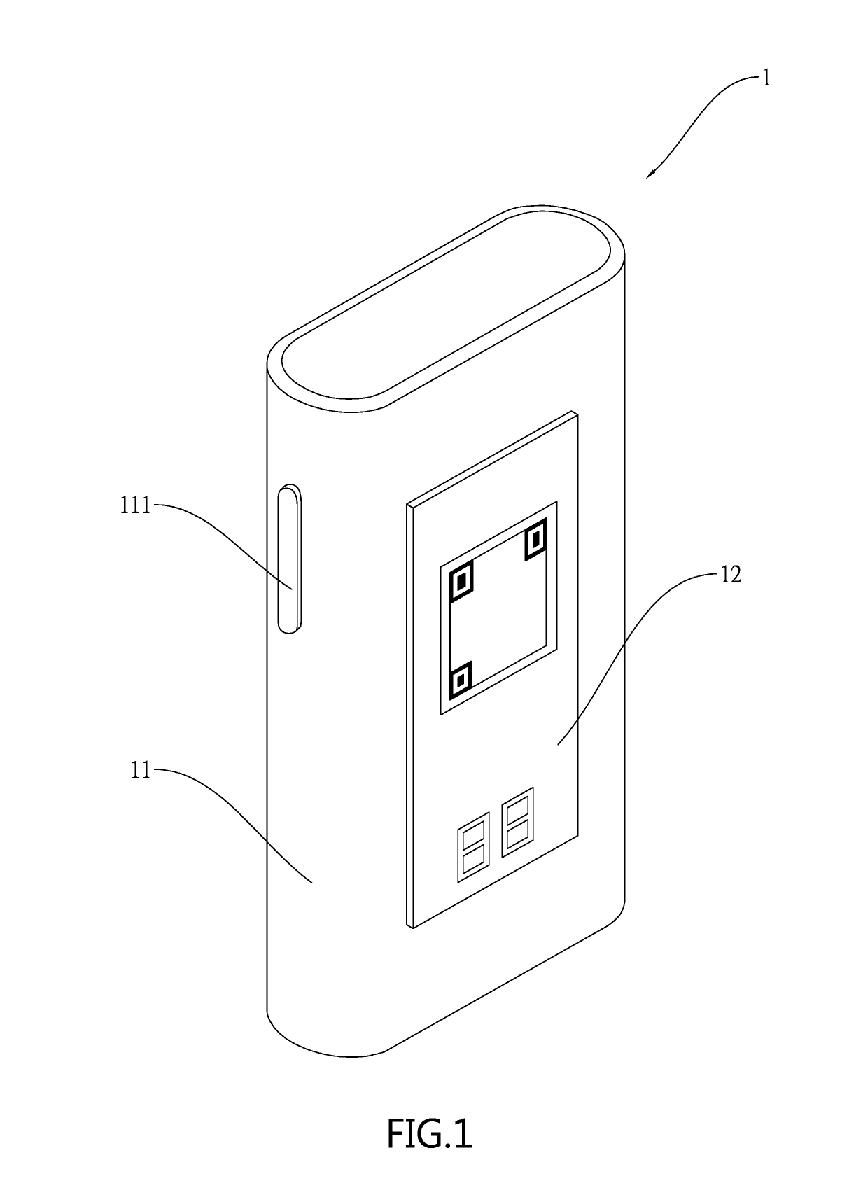

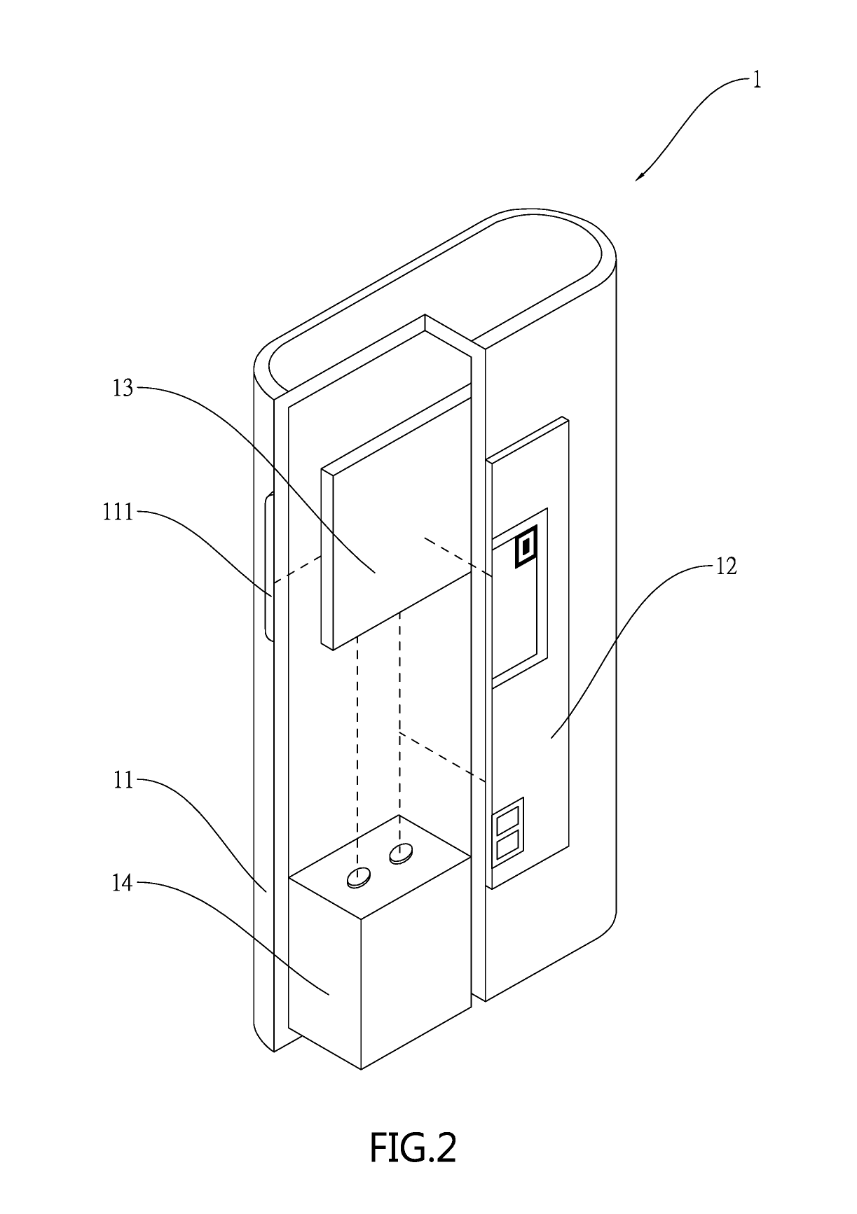

Referring to FIGS. 1 and 2, a device 1 for generating a limited-time 2D barcode symbol in accordance with a first preferred embodiment of the invention comprises a casing 11, a display (e.g., liquid-crystal display (LCD)) 12, a microcontroller unit (MCU) 13 and a power supply 14 as discussed in detail below.

The casing 11 is portable, hand-held and adapted to put in a pocket or a handbag or hang on the chest. The casing 11 includes a pushbutton 111. The display 12 is provided on a front surface of the casing 11 and adapted to show a barcode symbol in addition to logo, promotion information or the like. The MCU 13 is provided in the casing 11 and electrically connected to the pushbutton 111. The MCU 13 is adapted to generate a limited-time 2D barcode symbol by activating an internal barcode generator and generate a signal of predetermined time limit associated with the 2D barcode symbol by activating a time controller and send same to the display 12 to display the 2D barcode symbol for the predetermined time limit. After the predetermined time limit has expired, the 2D barcode symbol will be deleted. And in turn, the MCU 13 generates a next limited-time 2D barcode symbol by activating the internal barcode generator and generates a next signal of predetermined time limit associated with the next 2D barcode symbol by activating the time controller and send same to the display 12 to display the next 2D barcode symbol for another predetermined time limit. In addition, the MCU 13 can be activated wirelessly. For example, an individual may use a smartphone to activate the MCU 13 from a remote place. The activated MCU 13 may perform above functions. Alternatively, a user may press the pushbutton 111 to activate the MCU 13 which in turn instructs the display 12 to display another barcode symbol or delete the current barcode symbol. The power supply 14 is provided in the casing 11 and electrically connected to both the MCU 13 and the display 12. The power supply 14 is either a rechargeable battery or a primary cell.

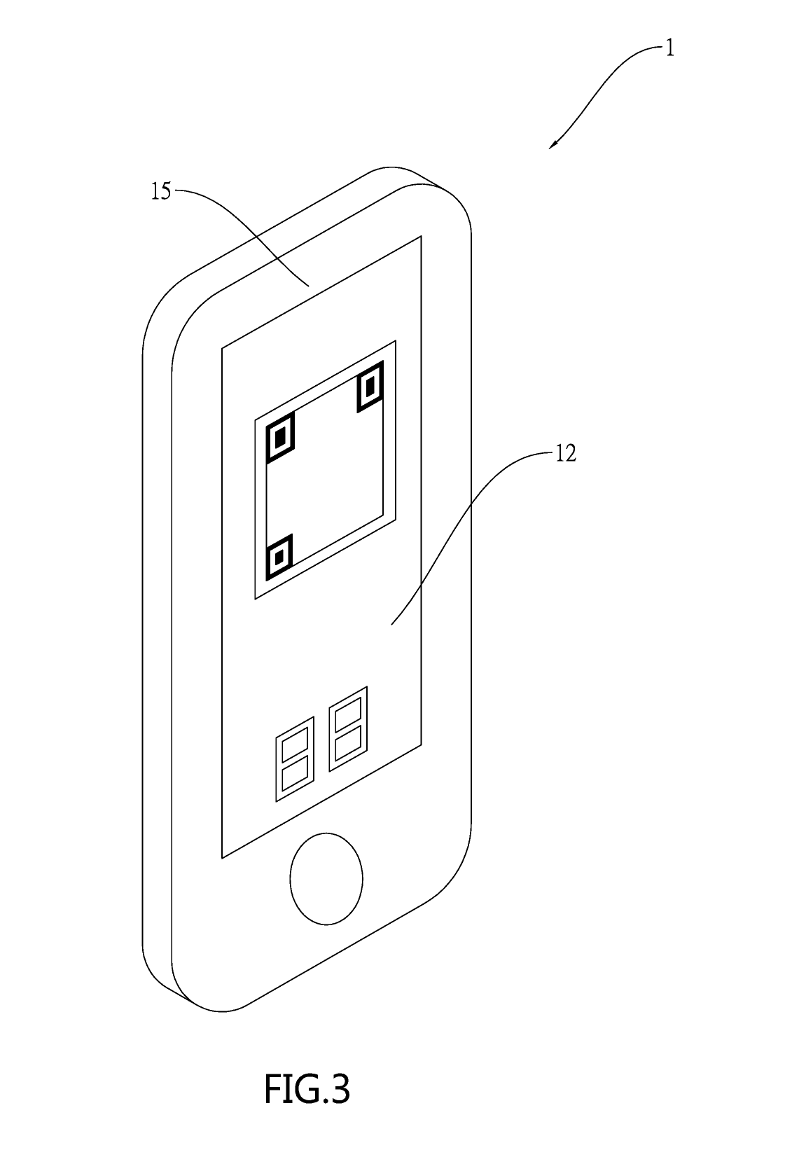

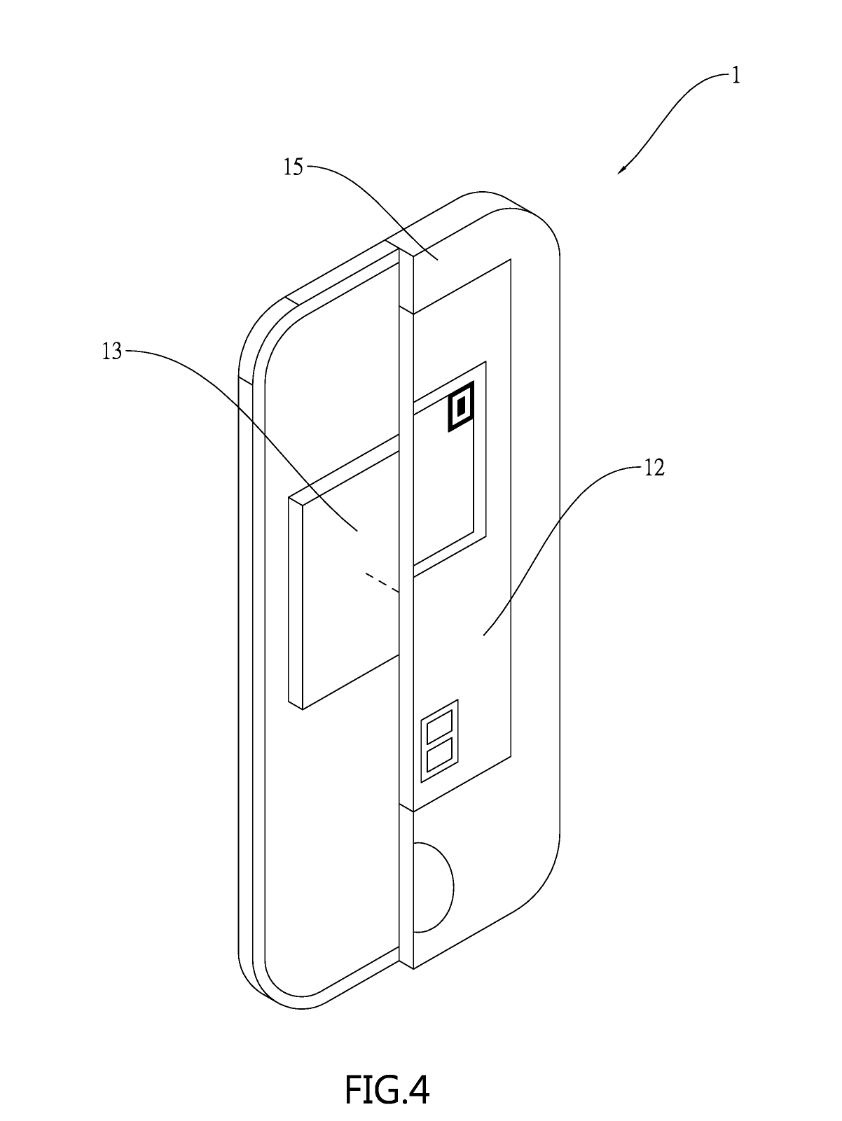

Referring to FIGS. 3 and 4, a device 1 for generating a limited-time 2D barcode symbol in accordance with a second preferred embodiment of the invention comprises a display (e.g., LCD) 12 and a MCU 13 as discussed in detail below.

The display 12 is adapted to show a barcode symbol in addition to logo, promotion information or the like. The display 12 is provided on a digital device (e.g., a computer, a tablet computer, a smartphone, or the like) 15. The MCU 13 is provided in the digital device 15 and electrically connected to the display 12. The MCU 13 is adapted to generate a limited-time 2D barcode symbol by activating an internal barcode generator and generate a signal of predetermined time limit associated with the 2D barcode symbol by activating a time controller and send same to the display 12 to display the 2D barcode symbol for the predetermined time limit. After the predetermined time limit has expired, the 2D barcode symbol will be deleted. And in turn, the MCU 13 generates a next limited-time 2D barcode symbol by activating the internal barcode generator and generates a next signal of predetermined time limit associated with the next 2D barcode symbol by activating the time controller and send same to the display 12 to display the next 2D barcode symbol for another predetermined time limit.

In addition, the MCU 13 can be activated wirelessly. For example, an individual may use a smartphone to activate the MCU 13 from a remote place. The activated

MCU 13 may perform above functions.

The invention has the following characteristics and advantages: the MCU may generate a limited-time 2D barcode symbol and send same to the display for display, or delete the 2D barcode symbol after the time limit has expired. Thus, the 2D barcode symbol is effective only during a set time period. Further, an individual may use a smartphone to activate the MCU to above perform above functions.

While the invention has been described in terms of preferred embodiments, those skilled in the art will recognize that the invention can be practiced with modifications within the spirit and scope of the appended claims.

What is claimed is:

1. A device for generating a limited-time 2D barcode symbol, comprising:
a casing;
a display disposed on the casing and configured to show a barcode symbol;
a microcontroller unit (MCU) disposed in the casing and electrically connected to the display, the MCU being configured to generate a limited-time 2D barcode symbol and send same to the display for display, or delete the 2D barcode symbol after a time limit of the 2D barcode symbol has expired; and
a power supply disposed in the casing and electrically connected to both the MCU and the display.

2. The device of claim 1, wherein the casing is portable.

3. The device of claim 1, wherein the casing includes a pushbutton electrically connected to the MCU.

4. The device of claim 1, wherein the MCU is configured to activate wirelessly.

5. The device of claim 1, wherein the power supply is a primary cell.

6. The device of claim 1, wherein the power supply is a rechargeable battery.

7. A device for generating a limited-time 2D barcode symbol, comprising:
a display disposed on a digital device and configured to show a barcode symbol; and
a microcontroller unit (MCU) in the digital device and electrically connected to the display, the MCU being configured to generate a limited-time 2D barcode symbol and send same to the display for display, or delete the 2D barcode symbol after a time limit of the 2D barcode symbol has expired.

8. The device of claim 7, wherein the MCU is configured to activate wirelessly.

9. The device of claim 7, wherein the digital device is a computer, a tablet computer, or a smartphone.
